(19) United States
(12) Patent Application Publication
(10) Pub. No.: US 2024/0251719 A1
(43) Pub. Date: Aug. 1, 2024

(54) LCO2 AS A MEANS TO CONTROL THE INNER ATMOSPHERE OF A GREENHOUSE IN TERMS OF ABSOLUTE MOISTURE AND TEMPERATURE

(71) Applicant: L'Air Liquide, Societe Anonyme pour l'Etude et l’Exploitation des Procedes Georges Claude, Paris (FR)

(72) Inventors: Oliveira ARAUJO, LISBOA (PT); Joseluis JIMENEZ, Alcala de Guadaira Sevilla (ES)

(73) Assignee: L'Air Liquide, Societe Anonyme pour l'Etude et l’Exploitation des Procedes Georges Claude, Paris (FR)

(21) Appl. No.: 18/290,069

(22) PCT Filed: May 6, 2022
(86) PCT No.: PCT/EP2022/062283

§ 371 Date: Nov. 9, 2023

(30) Foreign Application Priority Data
May 12, 2021 (EP) EP 21173646.7

(51) Int. Cl. A01G 9/24

(52) U.S. Cl. CPC A01G 9/246

(57) ABSTRACT

A method for managing operating conditions in a greenhouse, aiming to enable control:
of the temperature prevailing inside the greenhouse;
of the relative humidity of the atmosphere prevailing inside the greenhouse; characterized in that use is made of the latent heat of vaporization of liquid CO₂ as means for cooling the atmosphere inside the greenhouse, and for making it possible to condense the residual humidity in this atmosphere by bringing it below a lower limit, as follows:
one or more cryogenic liquid/air exchangers is disposed in the greenhouse;
during all or some of the day, liquid CO₂ is injected into the or some of the exchangers to exchange heat between the air inside the greenhouse and the cold walls of the one or more exchangers.

### CROSS-REFERENCE TO RELATED APPLICATIONS

This application is a § 371 of International PCT Application PCT/EP2022/062283, filed May 6, 2022, which claims § 119(a) foreign priority to EP patent application EP 21 17 3646, filed May 12, 2021.

### FIELD OF THE INVENTION

The present invention relates to the field of methods for controlling the atmospheres inside greenhouses for growing plants, fruits, vegetables or flowers.

### BACKGROUND

Specifically, it is known that control of the temperature and the amount of CO₂ gas in the atmosphere of such greenhouses is a very important factor for the proper operation of such spaces.

If consideration is given below to the case of plants, the temperature notably plays a major role in the growth and development of plants. In addition to optimization of the temperature, the concentration of CO₂ in the atmosphere must be managed since it has a strong influence on the growth of plants which consume CO₂ as part of the photosynthesis reaction, combining it with water to form sugars and oxygen. An excessively low level of concentration of CO₂ limits the growth of the plant, but an excessively high level of CO₂ does not benefit the plant.

It is also known that, in these greenhouse crops, the relative humidity is a key factor. Specifically, it is known that certain crops are very dense, in a limited and closed space, and that moreover the plants themselves “transpire” humidity.

It is also then observed in practice that there is a significant increase in the degree of humidity in such greenhouses and this is a problem since, in these deteriorated conditions, transpiration and the capacity of the plant to transport its nutrients and minerals can be impaired, and that is not forgetting the fact that these humid atmospheres promote the development of moss, which often goes unnoticed, and this can cause the fruits to rot and certain plant species to be destroyed, or cause certain infections to set in in yet other species, this of course having a heavy consequence in terms of productivity and the cost of using pesticides and fungicides.

It is also necessary, however, to consider the fact that a controlled degree of relative humidity during certain periods of the growth of certain plants may be very beneficial, and detrimental for others.

### SUMMARY OF THE INVENTION

One of the objectives of the present invention is then to propose a new method for controlling the degree of humidity prevailing in such greenhouses.

As will be seen in more detail below, the present invention proposes the adoption of the following technical approach:
using the latent heat of vaporization of liquid CO₂ as means for cooling the atmosphere inside the greenhouse (and thus limiting the increase in temperature in the greenhouse), and for making it possible to condense the residual humidity in this atmosphere, and eliminating this humidity from the system.
in closed greenhouses, with the use of artificial lighting, using the latent heat of vaporization of liquid CO₂ as means for controlling the temperature of the greenhouse.

It is notably known that, in the case of greenhouses in warm climates, after a certain time of day it is common to open ventilation windows in order to reduce the internal temperature or the degree of humidity.

A clear measurement is also then taken as to at what point the use of the latent heat of vaporization of liquid CO₂ can make it possible to delay the opening of these windows, this in parallel reducing the losses of CO₂ from the atmosphere inside the greenhouse toward the outside.

It is also possible notably to use for example an air/CO₂ exchanger for this, as illustrated in the appended FIG. 1, or even several of these exchangers distributed over the surface of the greenhouse.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is an example of using an air/CO₂ exchanger.

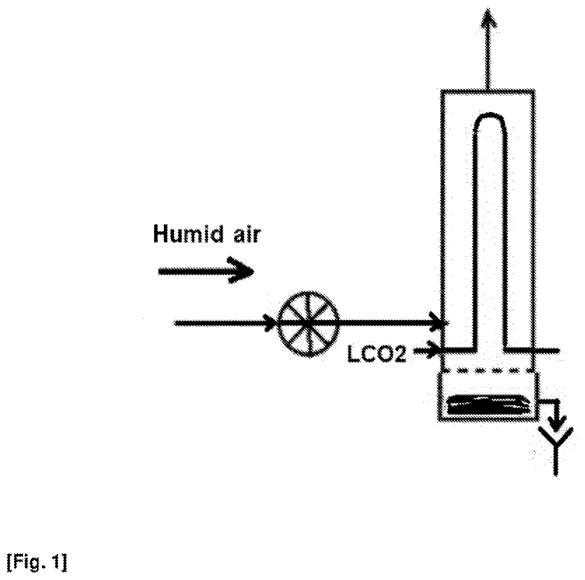

### DETAILED DESCRIPTION OF PREFERRED EMBODIMENTS

The present invention then relates to a method for managing operating conditions in a greenhouse, aiming notably to enable control:
of the temperature prevailing inside the greenhouse;
of the relative humidity of the atmosphere prevailing inside the greenhouse; characterized in that use is made of the latent heat of vaporization of liquid CO₂ as means for cooling the atmosphere inside the greenhouse, and for making it possible to condense the residual humidity in this atmosphere by bringing it below a lower limit, as follows:
one or more cryogenic liquid/air exchangers is disposed in the greenhouse;
during all or some of the day, liquid CO₂ is injected into the or some of the exchangers to exchange heat between the air inside the greenhouse and the cold walls of the one or more exchangers, and thus lower the temperature inside the greenhouse and condense all or some of the residual humidity of the internal atmosphere on the cold walls of the one or more exchangers.

The following text will illustrate an example of implementation of the invention, which will make it possible to properly understand all the technical advantages made possible by the invention.

This example has been implemented in the following operating conditions:
a greenhouse referred to as “multi-tunnel”
surface area of the greenhouse: 8340 m²
surface area taken up by plants: 75%
type of planting: zucchini
initial temperature inside the greenhouse: 28° C.
mean relative humidity at the start: 80%
air density at 28° C. and 80% relative humidity: 1.1462 kg/m³
duration of the campaign: 11 months
duration of daily injection of CO₂: 7 hours

The objective to be attained is as follows:
Mean relative humidity: 65%
Temperature in the greenhouse: 28° C.

This prompts the processing of 680 m³/h air in order to remove 12.3 kg H₂O/h by condensation.

The liquid CO₂ required to ensure this condensation is 100 kg/h.

For this example, two heat exchangers were installed inside the greenhouse. To ensure the air in the greenhouse mixes well with the dehumidified air coming from the exchangers, a fan was used.

To regulate the conditions of temperature and relative humidity inside the greenhouse, a programmable controller receives the measurements coming from a series of temperature and relative humidity probes, and makes it possible to control an all or nothing valve installed downstream of the heat exchangers as a function of the internal temperature and relative humidity of the atmosphere in the greenhouse, in order to thus adapt the inflow of liquid CO₂ into the greenhouse.

When the system is started up, a fan is started up to avoid the stratification of the atmosphere.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

As used herein, “about” or “around” or “approximately” in the text or in a claim means±10% of the value stated.

As used herein, “room temperature” in the text or in a claim means from approximately 20° C. to approximately 25° C.

The term “ambient temperature” refers to an environment temperature approximately 20° C. to approximately 25° C.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range. Any and all ranges recited herein are inclusive of their endpoints (i.e., x=1 to 4 or x ranges from 1 to 4 includes x=1, x=4, and x=any number in between), irrespective of whether the term “inclusively” is used.

All references identified herein are each hereby incorporated by reference into this application in their entireties, as well as for the specific information for which each is cited.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

1. (canceled)

2. A method for managing operating conditions in a greenhouse, aiming notably to enable control:
of the temperature prevailing inside the greenhouse;
of the relative humidity of the atmosphere prevailing inside the greenhouse; characterized in that use is made of the latent heat of vaporization of liquid CO₂ as means for cooling the atmosphere inside the greenhouse, and for making it possible to condense the residual humidity in this atmosphere by bringing it below a lower limit, as follows:
one or more cryogenic liquid/air exchangers is disposed in the greenhouse;
during all or some of the day, liquid CO₂ is injected into the or some of the exchangers to exchange heat between the air inside the greenhouse and the cold walls of the one or more exchangers, and thus lower the temperature inside the greenhouse and condense all or some of the residual humidity of the internal atmosphere on the cold walls of the one or more exchangers.
